(19) United States
(12) Patent Application Publication
(10) Pub. No.: US 2024/0371036 A1
(43) Pub. Date: Nov. 7, 2024

(54) APPARATUS AND METHOD FOR CAMERA CALIBRATION

(71) Applicants: HYUNDAI MOTOR COMPANY, Seoul (KR); KIA CORPORATION, Seoul (KR)

(72) Inventors: Sinhyun Jeon, Seoul (KR); Jinho Park, Seoul (KR); Jongmin Park, Incheon (KR)

(73) Assignees: HYUNDAI MOTOR COMPANY, Seoul (KR); KIA CORPORATION, Seoul (KR)

(21) Appl. No.: 18/424,256

(22) Filed: Jan. 26, 2024

(30) Foreign Application Priority Data
May 4, 2023 (KR) 10-2023-0058353

(51) Int. Cl. G06T 7/80; G06T 7/50; G06T 7/70

(52) U.S. Cl. CPC G06T 7/80; G06T 7/50; G06T 7/70; G06T 2207/20084; G06T 2207/30261

(57) ABSTRACT

A camera calibration apparatus includes a monocular camera configured to obtain an image of an environment of a vehicle, a memory storing a trained model configured to estimate a depth map of an input image, and a processor. The processor is configured to estimate a depth map of an image using the trained model, estimate a road profile including slope information included in the image based on the depth map of the image, and determine a distance to an object based on a location of the object located within the image and the road profile.

### CROSS-REFERENCE TO RELATED APPLICATION(S)

This application claims the benefit of and priority to Korean Patent Application No. 10-2023-0058353, filed on May 4, 2023, the entire contents of which are incorporated herein by reference.

### TECHNICAL FIELD

The present disclosure relates to a camera calibration apparatus and a camera calibration method capable of estimating a distance to an object using an image input from a monocular camera mounted on a vehicle.

### BACKGROUND

In general, autonomous driving uses location, perception, determination, and control technologies. Location and perception are preceded by observing the surrounding conditions, determining whether they are safe, and driving. To implement location and perception technology, it is essential to accurately determine the location of an object detected by a camera.

The position of an object detected by a monocular camera is represented based on an image coordinate system.

The conversion from an image coordinate system to a real-world coordinate system uses a homography matrix, which is generated in advance by camera calibration.

However, the homography matrix assumes that the ground is flat, so it is difficult to estimate the exact distance to an object on a road that is not flat, such as a slope, because the image captured by a monocular camera may not accurately estimate the position of the object.

### SUMMARY

Aspects of the present disclosure provide a camera calibration apparatus and a camera calibration method capable of accurately estimating a distance from a ramp to an object using an image input from a monocular camera.

Additional aspects of the present disclosure are set forth in part in the following description and should be, in part, understood from the description. Alternatively, additional aspects of the present disclosure may be learned by practice of the present disclosure.

In accordance with an embodiment of the present disclosure, a camera calibration apparatus includes a monocular camera configured to obtain an image of an environment of a vehicle, a memory storing a trained model configured to estimate a depth map of an input image, and a processor. The processor is configured to estimate a depth map of an image using the trained model, estimate a road profile including slope information included in the image based on the depth map of the image, and determine a distance to an object based on a location of the object located within the image and the road profile.

The processor may input the image into the trained model and may estimate the depth map of the image based on the depth map output from the trained model.

The trained model may include a monocular depth estimation network model.

The processor may set a road area as an area of interest, among the depth map output from the monocular depth estimation network model and may estimate the road profile in the area of interest.

The processor may define a road profile model in the area of interest, may obtain parameters of the road profile model that minimize an error between the road profile model and the depth map of the area of interest, and may estimate the road profile by applying the parameters of the road profile model to the road profile model.

The processor may obtain the parameters of the road profile model in which the error is minimized using Least Square method.

The processor may obtain image coordinates of the object located within the area of interest and may obtain real world coordinates of the object that minimize projection error based on the road profile and the image coordinates of the object.

The processor may obtain a projection error function between the image coordinates projected from the real world coordinates onto the road profile and the image coordinates of the object, using a homography matrix. The processor may also obtain a Jacobian matrix for a solution vector of the projection error function. The processor may also calculate an amount of change in the real world coordinates of the projection error function using the Jacobian matrix. The processor may also update the real world coordinates of the projection error function by applying the change in the real world coordinates. The processor may also obtain the real world coordinates at which the projection error function converges to 0.

The processor may set an initial value of the projection error function based on the road profile.

The processor may estimate the distance to the object based on the real world coordinates where the projection error function converges to 0.

In accordance with another embodiment of the present disclosure, a camera calibration method includes obtaining an image of an environment of a vehicle by a monocular camera. The method also includes estimating a depth map of the image using a model trained to estimate the depth map of the input image. The method also includes estimating a road profile including slope information of a road included in the image based on the depth map of the image. The method also includes determining a distance to an object based on a location of the object located within the image and the road profile.

Estimating the depth map of the image may further include inputting the image into the trained model and may further include estimating the depth map of the image based on the depth map output from the trained model.

The trained model may include a monocular depth estimation network model.

Estimating the road profile may further include setting a road area as an area of interest, among the depth map output from the monocular depth estimation network model and may further include estimating the road profile in the area of interest.

Estimating the road profile may further include defining a road profile model in the area of interest, obtaining parameters of the road profile model that minimize an error between the road profile model and the depth map of the area of interest, and estimating the road profile by applying the parameters of the road profile model to the road profile model.

Estimating the road profile may further include obtaining the parameters of the road profile model in which the error is minimized using Least Square method.

Estimating the distance of the object may further include obtaining image coordinates of the object located within the area of interest and may further include obtaining real world coordinates of the object that minimize projection error based on the road profile and the image coordinates of the object.

Estimating the distance of the object may further include obtaining a projection error function between the image coordinates projected from the real world coordinates onto the road profile and the image coordinates of the object, using a homography matrix. Estimating the distance of the object may further include obtaining a Jacobian matrix for a solution vector of the projection error function. Estimating the distance of the object may further include calculating an amount of change in the real world coordinates of the projection error function using the Jacobian matrix. Estimating the distance of the object may further include updating the real world coordinates of the projection error function by applying the change in the real world coordinates. Estimating the distance of the object may further include obtaining the real world coordinates at which the projection error function converges to 0.

Estimating the distance of the object may further include setting an initial value of the projection error function based on the road profile.

Estimating the distance of the object may further include estimating the distance to the object based on the real world coordinates where the projection error function converges to 0.

### BRIEF DESCRIPTION OF THE DRAWINGS

These and/or other aspects of the present disclosure should be apparent and more readily appreciated from the following description of the embodiments, taken in conjunction with the accompanying drawings, in which:

FIG. 1 is a control block diagram illustrating a camera calibration apparatus according to an embodiment of the present disclosure;

FIG. 2 is a flowchart explaining a camera calibration method according to an embodiment of the present disclosure;

FIG. 3 is a view illustrating a trained model of the camera calibration apparatus according to an embodiment of the present disclosure;

FIG. 4 is a flowchart explaining estimating a road profile in the camera calibration apparatus according to an embodiment of the present disclosure;

FIG. 5 is a view illustrating a road image input to a model trained in the camera calibration apparatus according to an embodiment of the present disclosure;

FIG. 6 is a depth map of a region of interest, which is a road area, among depth maps output from the model trained in the camera calibration apparatus according to an embodiment of the present disclosure;

FIG. 7 is a view of the road profile estimated by the camera calibration apparatus according to an embodiment of the present disclosure;

FIG. 8 is a flowchart explaining a process of estimating a distance from the camera calibration apparatus to an object located in the road image according to an embodiment of the present disclosure; and

FIGS. 9 and 10 are views illustrating the results of estimating the distance to the object using the road profile by the camera calibration apparatus according to an embodiment of the present disclosure.

### DETAILED DESCRIPTION

The following description is provided by way of example and is not intended to limit the present disclosure, application, or uses. It should be understood that, throughout the drawings, corresponding reference numerals indicate like or corresponding parts and features.

Reference is made below in detail to embodiments of the present disclosure, examples of which are illustrated in the accompanying drawings. The present disclosure does not describe all elements of the disclosed embodiments, and detailed descriptions of what is well known in the art or redundant descriptions on substantially the same configurations have been omitted. The terms ‘part’, ‘module’, ‘member’, ‘block’ and the like as used in the present disclosure may be implemented in software or hardware. Further, a plurality of ‘parts’, ‘modules’, ‘members’, ‘blocks’ and the like may be embodied as one component. It is also possible that one ‘part’, ‘module’, ‘member’, ‘block’ and the like includes a plurality of components. Each ‘part’, ‘module’, ‘member’, ‘block’, and the like as described herein may separately embody or be included with a processor and a memory, such as a non-transitory computer readable media, as part of the apparatus.

Throughout the present disclosure, when an element is referred to as being “connected to” another element, the element may be directly or indirectly connected to the other element and “indirectly connected to” includes being connected to the other element via a wireless communication network.

Also, it should be understood that the terms “include” and “have” and variations thereof are intended to indicate the existence of elements disclosed in the present disclosure and are not intended to preclude the possibility that one or more other elements may exist or may be added.

Throughout the present disclosure, when a member is located “on” another member, this includes not only a situation where one member is in contact with another member but also a situation where another member is present between the two members.

The terms first, second, and the like are used to distinguish one component from another component, and the components are not limited by the terms described above.

An expression used in the singular encompasses the expression of the plural, unless it has a clearly different meaning in the context.

The reference numerals used in operations are used for descriptive convenience and are not intended to describe the order of operations. The operations may be performed in a different order unless otherwise stated.

When a component, device, element, part, module, member, block, or the like of the present disclosure is described as having a purpose or performing an operation, function, or the like, the component, device, element, part, module, member, block, should be considered herein as being “configured to” meet that purpose or to perform that operation or function.

Hereinafter, embodiments of the present disclosure are described in detail with reference to the accompanying drawings.

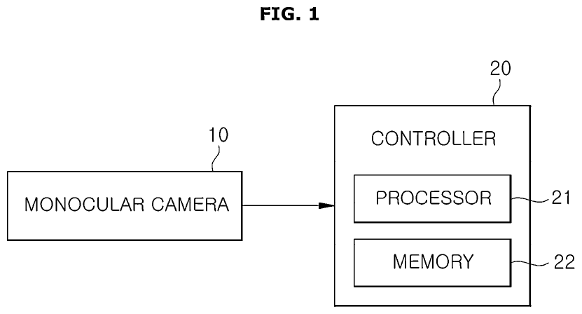

FIG. 1 is a control block diagram illustrating a camera calibration apparatus according to an embodiment of the present disclosure.

Referring to FIG. 1, a vehicle to which a camera calibration apparatus is applied may detect objects in the surrounding environment (e.g., nearby vehicles, pedestrians, cyclists, lanes, road signs, curbs, medians, road boundaries, buildings, and the like, and control driving and/or braking and/or steering of the vehicle in response to the detected environment.

The vehicle may provide various functions to a driver. For example, in order to provide an autonomous driving system, the vehicle may include Lane Departure Warning (LDW), Lane Keeping Assist (LKA), High Beam Assist (HBA), Automatic Emergency Braking (AEB), Traffic Sign Recognition (TSR), Smart Cruise Control (SCC), Blind Spot Detection (BSD), and the like.

As shown in FIG. 1, the camera calibration apparatus may include a monocular camera 10. In addition to the monocular camera 10, the camera calibration apparatus may be equipped with a radar and a light detection and ranging (LiDAR).

The monocular camera 10 may be an RGB (Red/Green/Blue) camera that acquires RGB images and may include a Charge couple device (CCD) or a Complementary Metal Oxide Semiconductor (CMOS) image sensor.

The monocular camera 10 may be installed at different locations in the vehicle.

For example, the monocular camera 10 may include a front view camera, a front and lateral side view camera, a rear and lateral side view camera, or a rear view camera.

The front camera may be mounted on a front windshield of a vehicle to provide a forward field of view. The front camera may capture in front of the vehicle and obtain image data in front of the vehicle. The front camera may detect any moving objects in a forward-facing (including front view and lateral side view) field of view or may detect objects travelling in adjacent lanes in a front and side field of view. The image data in front of the vehicle may include information about an object located in front of the vehicle (e.g., nearby vehicles, pedestrians, cyclists, traffic lanes, road signs, curbs, medians, road boundaries, buildings, and the like.

The front and lateral side view camera may be mounted on a front side of the vehicle, such as the A-pillar or B-pillar, to provide the forward-facing field of view. The front and lateral side view camera may capture the front and both sides of the vehicle and obtain image data of the front and both sides of the vehicle.

The rear and lateral side view camera may be mounted on a rear side of the vehicle, such as the C-pillar of the vehicle, to provide a rearward-facing (including rear view and lateral side view) field of view. The rear and lateral side view camera may capture the rear and both sides of the vehicle and obtain image data of the rear and both sides of the vehicle.

The rear camera may be mounted on the rear side of the vehicle, such as a rear bumper, to provide a rear-facing field of view. The rear camera may capture the rear of the vehicle and obtain image data of the rear of the vehicle.

The camera calibration apparatus may include a controller 20 for performing overall control.

The controller 20 may be electrically connected to the monocular camera 10.

When performing an autonomous driving system, the controller 20 may identify objects in the image based on image data obtained by the monocular camera 10. The controller 20 may also determine whether the objects are an obstacle in a stationary state or an obstacle in a moving state by comparing information on the identified objects with object information stored in a memory 22.

The objects in the stationary state may include lanes, road signs, curbs, medians, road boundaries, buildings, or the like. The objects in the moving state may include cyclists, other vehicles, bikes, pedestrians, or the like.

The controller 20 may include a processor 21 and the memory 22. The processor 21 may be hardware and may include logic and arithmetic circuits. The processor 21 may control various electrically connected devices of the vehicle using programs, instructions, and/or data stored in the memory 22 for operation of the vehicle. The controller 20 may be implemented as a control circuit including circuit elements, such as capacitors, inductors, and resistance elements. The processor 21 and the memory 22 may be implemented as separate chips or as a single chip. Furthermore, the controller 20 may include a plurality of processors and a plurality of memories.

The memory 22 may store a model trained to estimate a depth map of an input image. The trained model may include a monocular depth estimation network model.

The memory 22 may store programs, applications, and/or data for the operation of the vehicle and may store data generated by the processor 21. The memory 22 may include non-volatile memory, such as Read Only Memory (ROM) or flash memory, for storing data for long-term. The memory 22 may include volatile memory, such as Static Random Access Memory (S-RAM) or Dynamic Random Access Memory (D-RAM), for temporarily storing data.

As described above, in autonomous driving, accurate location information of objects identified by a monocular camera is required.

The location of the object identified by the monocular camera may be represented based on the image coordinate system.

The conversion from the image coordinate system to the real world coordinate system is referred to as camera calibration.

To perform the camera calibration, it is necessary to obtain internal and external parameters of the camera. The internal parameters may refer to internal information of the camera, such as lens distortion, and the external parameters may refer to motion and rotation information of the camera. For this purpose, mathematically, matrices and vectors are used to represent a three-dimensional (3D) coordinates of the real world as a two-dimensional (2D) image plane, and a homography matrix may be used to find and change features in the image.

As such, a conventional camera calibration uses a homography matrix. The homography matrix is used to find the correspondence between the 2D image coordinates in the image and the 3D real world coordinates.

The homography matrix method may be a relatively simple way of finding correspondences during the camera calibration, but the homography matrix is only applicable when a projection has been made and has the limitation of not being able to represent changes in the shape of a road, such as a ramp. In other words, since the homography matrix is created based on the assumption that the ground is flat (z=0), the exact position of the object on the ramp (z #0) may not be estimated from a monocular image without depth information, so it is difficult to estimate an exact distance to the object. For reference, it is also possible to obtain depth information of an image using multiple cameras, but this requires the use of multiple cameras and a large amount of calculations, so it is not suitable for real-time processing.

Therefore, there is a need for a method to accurately estimate a distance from a ramp to an object using the image input by the monocular camera.

To this end, the controller 20 may estimate a depth map of a road image obtained by the monocular camera 10 using the trained model stored in the memory 22. The controller 20 may also estimate a road profile from the road image based on the depth map of the road image and may determine a distance to an object located in the road image based on the road profile.

The controller 20 may input the road image obtained by the monocular camera 20 into a monocular depth estimation network model, which is a trained model and may estimate the depth map of the road image based on the depth map output from the monocular depth estimation network model.

The controller 20 may set a road area as an area of interest among the depth map output from the monocular depth estimation network model and may estimate the road profile in the area of interest.

The controller 20 may define a road profile model in the area of interest, may calibrate parameters of the road profile model such that the error between the road profile model and the output depth map is minimized, and may apply the calibrated parameters to the road profile model to estimate the road profile.

The controller 20 may estimate the 3D real world coordinates of the object using the 2D image coordinates of the object located in the road image obtained by the monocular camera 10 and the road profile. The controller 20 may also estimate the distance to the object based on the 3D real world coordinates of the object.

The controller 20 may control multiple functions of the vehicle depending on the distance to the object.

The controller 20 may estimate the slope of the road within the road image based on the road profile.

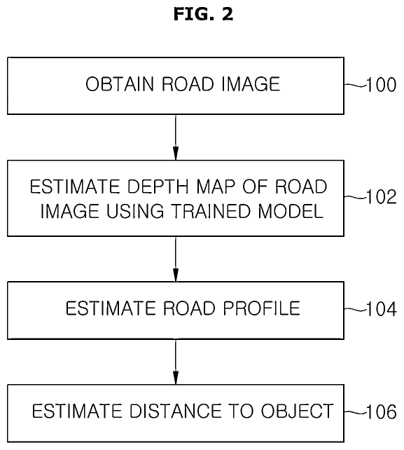

FIG. 2 is a flowchart explaining a camera calibration method according to an embodiment of the present disclosure.

Referring to FIG. 2, the controller 20 may obtain the road image through the monocular camera 10 (operation 100).

The controller 20 may obtain the road image, which is an image including roads and objects around the vehicle, through the monocular camera 10 (operation 100).

The controller 20 may estimate the depth map of the road image using the trained model (operation 102).

The trained model may be a model trained so as to estimate the depth map of the input image. Upon being input of the road image, the trained model may predict depth values of all pixels of the input road image and may generate and output the depth map of the road image based on the predicted depth values.

The controller 20 may estimate the depth map output from the trained model as the depth map of the road image.

The controller 20 may estimate the road profile of the road image based on the depth map of the road image (operation 104).

The controller 20 may extract the road area from the depth map of the road image and may estimate the slope of the road based on the depth values of pixels in the road area. In the road area, an area of the road area close to a flat surface may have a small slope, and the further away, the large the slope. Therefore, the slope of the road may be estimated based on the depth values of pixels in the road area. The road profile may be estimated using road slope information.

The controller 20 may estimate the distance (x, y, z) to the object in the road image based on the road profile (operation 106).

The controller 20 may estimate the homography matrix based on the road profile with the road slope information and may use the homography matrix to convert the 2D image coordinates (u, v) of the object in the road image into the 3D real world coordinates (x, y, z). At this time, the depth value of the road profile may be used to determine the z-axis coordinate. The distance to the object may be determined from the real world coordinates (x, y, z) of the object.

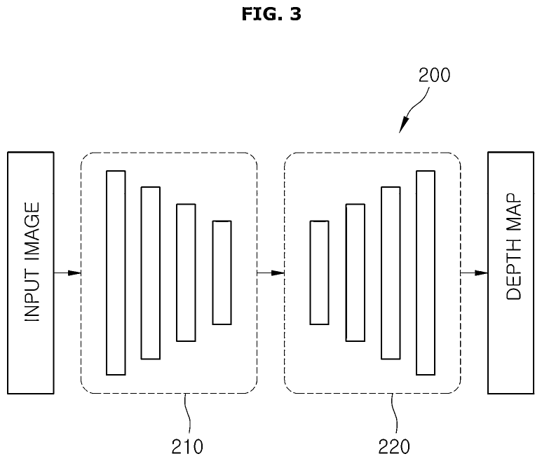

FIG. 3 is a view illustrating the trained model of the camera calibration apparatus according to an embodiment of the present disclosure.

Referring to FIG. 3, the trained model may be a model trained so as to estimate a depth map of an image and may be a monocular depth estimation network model 200.

The monocular depth estimation network model 200 may be a model that uses a monocular image as an input to predict the depth values of all pixels in the image. The monocular depth estimation network model 200 may estimate the depth of the monocular image using a neural network.

The monocular depth estimation network model may be implemented using a convolutional neural network (CNN) with an encoder-decoder structure.

To this end, the monocular depth estimation network model 200 may include an encoder 210 and a decoder 220.

The monocular depth estimation network model 200 may predict the depth values of all pixels in the input image in a manner that it first encodes the input image via an encoder 210 to convert the input image into a low dimensional representation of a latent space and then predicts the depth values of the pixels in the input image via a decoder 220 by upsampling the output of the encoder 220 to progressively higher resolution pixels. The monocular depth estimation network model 200 may also output by generating the depth map based on the predicted depth values.

More specifically, the encoder 210 may receive the input image and serve to extract features from the input image. The encoder 210 typically is composed of convolution layers, and each of the convolution layers converts the input image into feature maps of different sizes. These feature maps represent various abstract features of the input image, and the extracted feature maps are used by the decoder 220 for depth estimation.

The decoder 220 may receive the feature maps extracted from the encoder 210 as input and may combine the feature maps to generate a final depth estimation result. The decoder 220 typically may generate a final depth map by increasing the size of the feature map by using layers, such as transposed convolution or upsampling. The decoder 220 may output the depth map. Each pixel on the depth map may correspond to the distance of the nearest object in the image projected thereon.

The monocular depth estimation network model 200 may employ supervised learning, unsupervised learning, self-supervised learning, or the like. For example, representative models may include Deeper Depth Prediction with Fully Convolutional Residual Networks (FCRN), Deep Ordinal Regression Network for Monocluar Depth Estimation (DORN), Unsupervised Monocular Depth Estimation with Left-Right Consistency (Monodepth), Digging into Self-Supervised Monocluar Depth Prediction (Monodepth2), and the like. The representative models are not limited to the above examples.

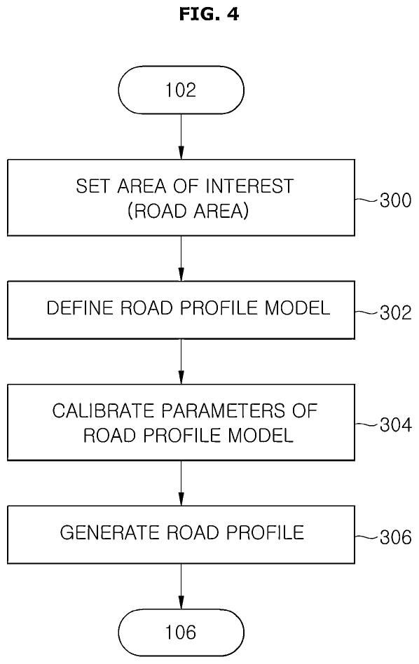

FIG. 4 is a flowchart explaining estimating the road profile in the camera calibration apparatus according to an embodiment of the present disclosure.

Referring to FIG. 4, the controller 20 may extract the road area from the depth map of the road image and may set the road area as the area of interest (operation 300).

The controller 20 may extract the road area from the depth map of the road image. The controller 20 may determine a pixel area in which the depth value of the pixel in the depth map of the road image is less than or equal to a predetermined threshold, as the road area. The controller 20 may set the road area as the area of interest.

The controller 20 may define the road profile model (operation 302).

The controller 20 may define the road profile model (z(x)) as shown in the following equation [1].

$$z ( x ) = {c}_{3} {x}^{3} + {c}_{2} {x}^{2} + {c}_{1} x + {c}_{0} \qquad Equation [ 1 ]$$

In Equation 1, c3, c2, c1, and c0 may be parameters of the road profile model.

The controller 20 may calibrate parameters of the road profile model (z(x)) in the area of interest (operation 304). The controller 20 may calibrate initial values of the parameters of the road profile model (z(x)) to updated values by comparing the depth values of all pixels in the area of interest.

For example, the controller 20 may calibrate the parameters of the road profile model by calculating c3, c2, c1, and c0 where an error is minimized using the least square method.

The error may be represented by the following equation [2].

$$error = \frac{1}{N} {\sum }_{i = 1}^{N} {‖ {c}_{3} {x}_{i}^{3} + {c}_{2} {x}_{i}^{2} + {c}_{1} {x}_{i} + {c}_{0} - {z}_{i} ‖}^{2} \qquad Equation [ 2 ]$$

The least square method is a method of minimizing the error between predicted values and actual values when creating a model to describe the distribution of data. The controller 20 may find a curve that best describes the pixel depth distribution data using the least square method. In doing so, the sum of the errors should be minimized. The controller 20 may determine the suitability of the parameters of the road profile model (z(x)) for the given pixel depth distribution data using the least square method. For example, the least square method may be used to determine the relationship between an independent variable X that describes a certain dependent variable Y. In this case, the least square method may find a regression model that best describes the relationship between Y and X. Such a regression model may be used to estimate an accurate regression model by calculating model parameters that minimize the error of the prediction model using the least squares method.

The controller 20 may generate the road profile based on the calibrated road profile model parameters c3, c2, c1, and c0.

The controller 20 may generate the road profile in the form of a function representing the slope information of the road by applying the calibrated road profile model parameters c3, c2, c1, and c0 to the road profile model (operation 306).

As such, the slope of the road may be estimated using the depth values of pixels in the area of interest, which is the road area. The slope may indicate the degree of upward or downward tilt in the area of interest. To estimate the slope, a different in depth at each pixel may be calculated while moving up and down in the area of interest. The slope in a vertical direction may be estimated from the change in depth values. For example, an area where the depth value changes rapidly may be assumed to have a large slope, while an area where the depth value does not change may be assumed to be flat. The slope information may be represented as an equation and used to calculate the road profile within the road image.

With the above operations, the depth map of the area of interest, which is the road area in the road image, may be used to calculate the road profile, which is a function representing the slope of the road in the area of interest.

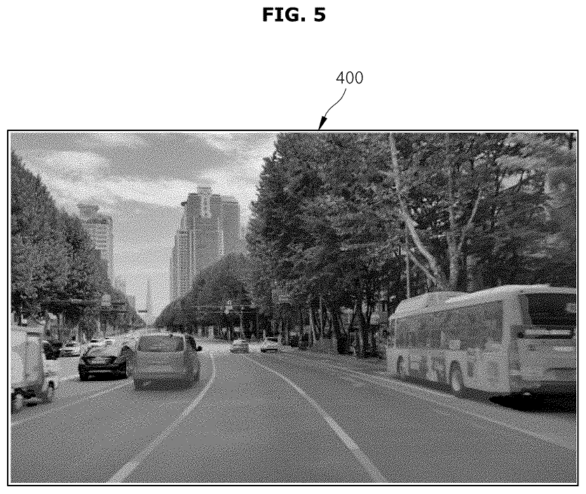

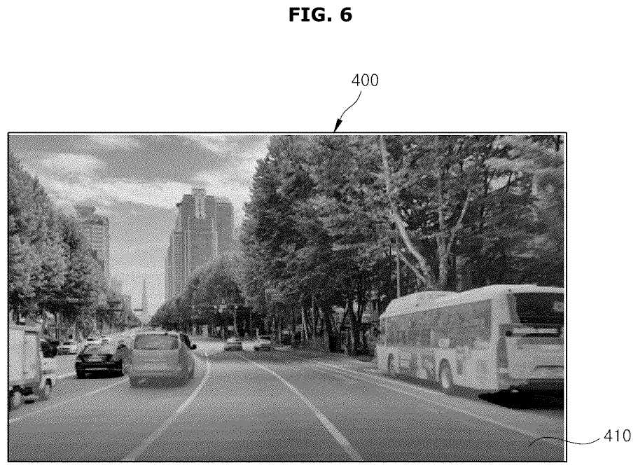

FIG. 5 shows the road image input to the model trained in the camera calibration apparatus according to an embodiment of the present disclosure. FIG. 6 shows the depth map of the area of interest, which is the road area, among the depth maps output from the model trained in the camera calibration apparatus according to an embodiment of the present disclosure.

Referring to FIGS. 5 and 6, the depth map of the area of interest 410, which is the road area, in the road image 400, which is an RGB image, may typically use color to visualize the depth information. This may be referred to as depth representation by color.

To create the depth representation for each color, the depth value of each pixel in the area of interest 410 may be first determined.

Since depth values are typically expressed as real numbers, the depth values are converted into integer values by scaling them to an appropriate range. The converted depth value may then be displayed as a color using a color map. For example, red may represent the highest depth, while blue may represent the lowest depth. Other colors, such as green, yellow, orange, and purple, may represent depth values between red and blue.

A correspondence between depth values and colors may be defined. The correspondence between depth values and colors may be non-linear and may be adjusted to obtain an appropriate depth representation for each color.

The use of the depth representation for each color created by the above manner may be used to determine the depth information of the area of interest 410. For example, areas of low depth may be represented by blue, while areas of high depth may be represented by purple or red. This may allow the depth information of the area of interest 410 to be easily identified.

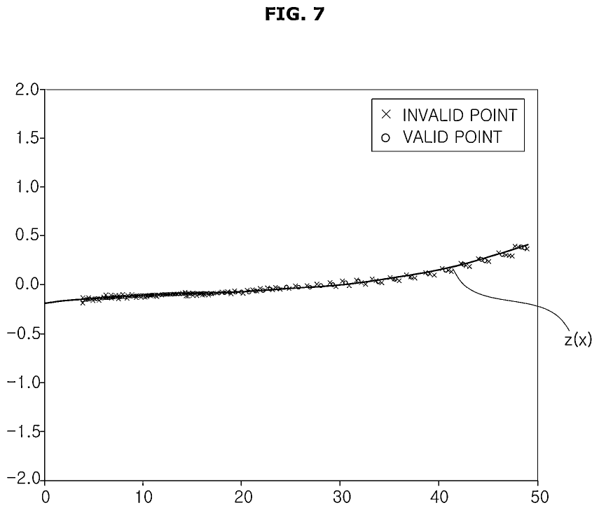

FIG. 7 shows the road profile estimated by the camera calibration apparatus according to an embodiment of the present disclosure.

Referring to FIG. 7, after estimating the depth information of the area of interest 410, which is the road area, the road profile function (z(x)) may be generated based on the depth information of the area of interest 410.

The road profile function may be a function that represents the change in depth values along the road area. The function may represent the change in depth values within the area of interest, usually in the vertical direction. The road profile function may be used to analyze the characteristics of a road. The road profile function may be used to determine the characteristics of the road, such as the slope and curvature.

In FIG. 7, the vertical axis represents depth, and the horizontal axis represents distance.

When creating the road profile function, a process of applying valid and invalid points is as follows.

First, valid points may be selected. A valid point may refer to a pixel with a depth value that may be used to generate a road profile function. In general, when creating the road profile function, depth values are extracted at regular intervals. At this time, not all the extracted depth values are valid. For example, if some of the extracted depth values are unreliable due to noise or outliers, these values should be treated as invalid values.

Then, invalid points may be removed. An invalid point may refer to a pixel that may not be used to generate a road profile function. Such pixels do not have valid depth values, so they should not affect the generation of the road profile function. For example, if some of the extracted depth values are in areas outside the road or are pixels that are not located on the road, these pixels should be treated as invalid points.

The valid points may then be used to create the road profile function. After selecting valid points and removing invalid points, the remaining valid points may be used to generate the road profile function. This may typically be achieved using methods, such as linear regression or polynomial regression. The regression model may generate the road profile function by using the depth values and coordinate information of the valid points.

Finally, the road profile function may be verified. The road profile function needs to be verified to reflect the actual shape of the road. This may be achieved by analyzing the characteristics of the road, such as the slope and curvature.

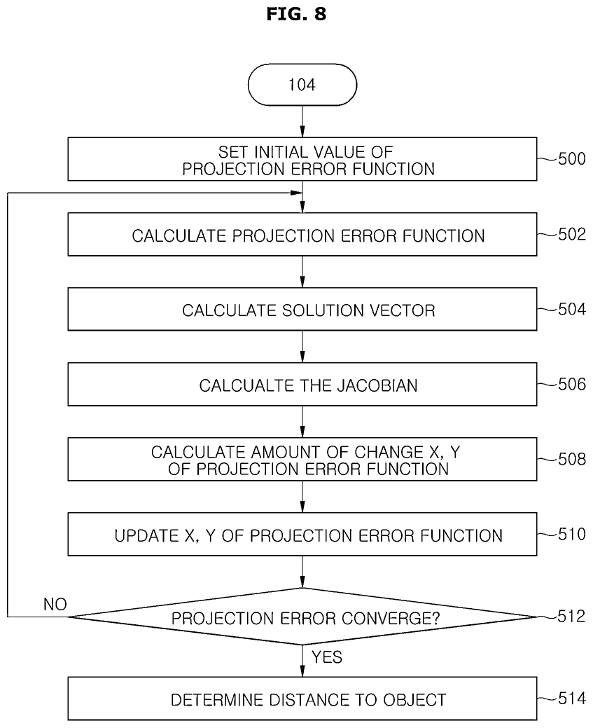

FIG. 8 is a flowchart explaining a process of estimating the distance to the object located within the road image in the camera calibration apparatus according to an embodiment of the present disclosure.

Referring to FIG. 8, it is necessary to satisfy the assumption that the image coordinates of the real world coordinates of any object projected onto the road profile should match the image coordinates of the object whose distance is to be obtained. Under such an assumption, the Jacobian for a solution vector of the projection error function may be used to optimize the real world coordinates of the projection error function in such a way that the projection error is minimized.

First, the controller 20 may set an initial value of the projection error function (operation 500).

An initial estimate value is needed be set in order to estimate the real world coordinates that are parameters of the projection error function. At this time, due to the nature of the non-linear equation, if the initial estimate value is set incorrectly, the initial estimate value may diverge or converge to an incorrect value. Therefore, by setting the initial estimate value to the value of a primary road profile (z(x)=c1x+c0), reliable optimization may be achieved.

The controller 20 may calculate the projection error function (operation 502).

The controller 20 may use the homography matrix to calculate the projection error function between the image coordinates (uproj, vproj) projected from the real world coordinates (x, y) onto the road profile (z(x)) and the image coordinates (u, v) of the object whose distance is to be obtained.

The projection error (Eproj) may be expressed by the following equation [3].

$${E}_{proj} = [ \begin{matrix}{e}_{u} \\ {e}_{v}\end{matrix} ] = [ \begin{matrix}{u}_{proj} - u \\ {v}_{proj} - v\end{matrix} ] = H ( ρ , z ( x ) ) - [ \begin{matrix}u \\ v\end{matrix} ] \qquad Equation [ 3 ]$$

In Equation 3, eu is the u-axis error, ev is the v-axis error, uproj and vproj are the projected image coordinates, u is the image coordinate of the object whose distance is to be obtained, z(x) is the road profile, ρ is the real world coordinate (x, y), and H(ρ, z(x)) is the image coordinate project from the real world coordinates (x, y) onto the road profile (z(x)) using the homography matrix. The homography matrix is a matrix that represents the transformation between the image coordinates and the real world coordinates.

To recap, the projection error function (f(ρ)) may be expressed as the following equation [4].

$$f ( ρ ) = H ( ρ , z ( x ) ) - [ \begin{matrix}u \\ v\end{matrix} ] \qquad Equation [ 4 ]$$

In Equation 4, H(ρ, z(x)) may be expressed as follows in equation [5].

$$H ( ρ , z ( x ) ) = [ \begin{matrix}\frac{{h}_{00} x + {h}_{01} y + {h}_{02} z ( x ) + {h}_{03}}{{h}_{21} x + {h}_{22} y + {h}_{23} z ( x ) + {h}_{23}} \\ \frac{{h}_{10} x + {h}_{11} y + {h}_{12} z ( x ) + {h}_{13}}{{h}_{21} x + {h}_{22} y + {h}_{23} z ( x ) + {h}_{23}}\end{matrix} ] \qquad Equation [ 5 ]$$

In Equation 5, h00 to h23 are parameters of the homography matrix.

The controller 20 may obtain the solution vector (operation 504).

The controller 20 may calculate the solution vector of the projection error function after calculating the projection error function. The solution vector represents the projection error function in vector form. The solution vector may indicate a direction in which the real world coordinates should be adjusted so that the projection error is minimized.

The controller 20 may obtain the Jacobian (operation 506).

The controller 20 may calculate a Jacobian J for the solution vector of the projection error function. The Jacobian J is a matrix consisting of the differential values for each element of the solution vector of the projection error function. The Jacobian J may be used to calculate the gradient of the projection error function.

The Jacobian J may be expressed as the following equation [6] from the projection error function (f(ρ)).

$$J = \frac{\partial f ( {ρ}_{k - 1} )}{\partial {ρ}_{k - 1}} \qquad Equation [ 6 ]$$

The controller 20 may calculate an amount of change (Δρ) in the real world coordinates (x, y) of the projection error function using the Jacobian matrix (operation 508).

The amount of change (Δρ) in the real world coordinates may be expressed in the following equation [7].

$$Δρ = {[ {J}^{T} J ]}^{- 1} {J}^{- T} f ( {ρ}_{k - 1} ) \qquad Equation [ 7 ]$$

The controller 20 may update the real world coordinates (x, y) by applying the amount of change (Δρ) of the real world coordinates (x, y) of the projection error function (operation 510).

The updated the real world coordinates (ρk) may be expressed in the following equation [8].

$${ρ}_{k} ← {ρ}_{k - 1} + Δρ \qquad Equation [ 8 ]$$

The controller 20 may determine whether the projection error converges (operation 512).

For example, when the projection error function does not converge to 0 (No in operation 512), the controller 20 may move to operation 502 and may perform the following operations. The controller 20 may perform the operations repeatedly until the projection error function converges to 0.

When the projection error function converges to 0 (Yes in operation 512), the controller 20 may determine the distance to the object based on the real world xy-axis coordinates at which the projection error function converges to 0 and the real world z-axis coordinates obtained from the road profile (z(x)) at that time (operation 514).

As such, the present disclosure may estimate the accurate distance to the object by estimating the road profile even in a situation where there is an object ahead and by determining the real world coordinates based on the road profile. In addition, the present disclosure may estimate the road profile regardless of the illuminance of a pattern or image drawn on the road surface and thus may estimate the accurate distance to the object regardless of the type or illuminance of the road.

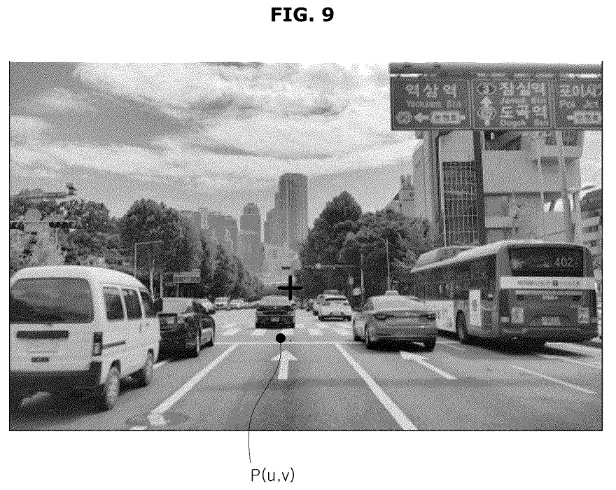

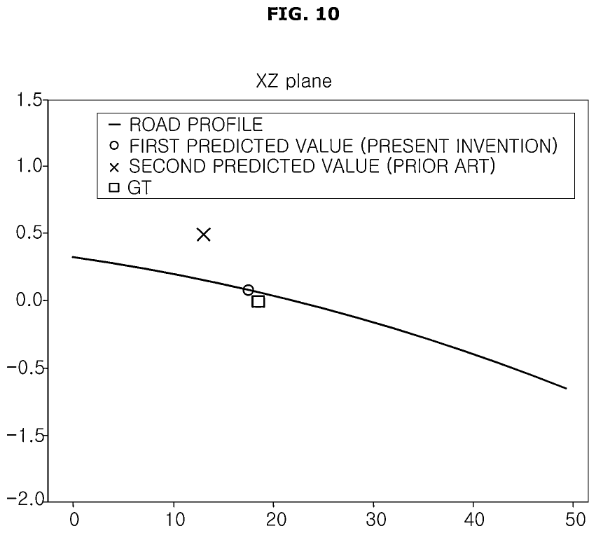

FIGS. 9 and 10 show the results of estimating the distance to the object using the road profile by the camera calibration apparatus according to an embodiment of the present disclosure.

Referring to FIGS. 9 and 10, for the image coordinates P (u, v) for which the distance to the object in the road image is desired to be known, the result of comparison between a first predicted value, which is a 3D real world coordinate value predicted by the present disclosure, and a second predicted value e, which is a 2D real world coordinate value predicted in a conventional manner, is shown.

In FIG. 10, the horizontal axis may represent a distance and the vertical axis may represent a slope of the road.

To determine whether the first predicted value predicted by the present disclosure is accurate compared to the second predicted value predicted in the conventional manner, it is common to compare a difference between the first predicted value and the ground truth (GT) and a difference between the second predicted value and the GT. As these differences are smaller, it is determined that the predicted value is the more accurate.

In the present disclosure, the first predicted value is based on the road profile with the depth map output from the trained model and thus may appear on the road profile.

Accordingly, it can be seen that the first predicted value predicted by the present disclosure is closer to the GT than the second predicted value predicted by the prior art.

For example, if the GT on a descending ramp is Pgt (18.26, 0.62, −0 49), the second predicted value predicted by the prior art is P1 (12.98, 0.54, 0). As a result, the experiments show that there is an error of 28.9% compared to the GT.

However, the first predicted value predicted by the present disclosure is P2 (17.46, 0.61, −0.41). As a result, the experiments show that there is an error of 4.3% compared to the GT.

Since the first predicted value predicted by the present disclosure is based on the road profile with the road depth information, it can be seen that the first predicted value is closer to the GT than the second predicted value predicted by the conventional manner. Therefore, the present disclosure may predict the GT more accurately than the conventional manner.

On the other hand, the embodiment described above describes a method for estimating the road profile with the depth map using a trained model but is not limited thereto. It is also possible to use a method using LiDAR. For example, LiDAR may be used to measure the topography of a road and estimate a road profile based on the measurement. LiDAR may generate accurate, high-resolution data, such as a depth map, allowing the slope and curvature of the road to be identified with high accuracy. It is also possible to use a method for recognizing road boundaries. Road profiles are formed based on road boundaries. Therefore, the road boundaries may be recognized, and then the road profile may be estimated based on the recognized road boundaries. Meanwhile, it is also possible to use a method for recognizing lanes. Lane recognition may provide useful information for estimating a road profile. By recognizing lanes, the curvature and slope of the road may be estimated. As such, unlike the trained model that estimates the depth map, the road profile may be estimated using a variety of sensors.

As should be apparent from the above, various embodiments of the present disclosure may estimate accurately the distance from the ramp to object using the image input by the monocular camera.

On the other hand, the above-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the present disclosure have been shown and described, it should be appreciated by those having ordinary skill in the art that changes may be made in these embodiments without departing from the principles and spirit of the present disclosure, the scope of which is defined in the claims and their equivalents.

What is claimed is:

1. A camera calibration apparatus, comprising:
a monocular camera configured to obtain an image of an environment of a vehicle;
a memory storing a trained model configured to estimate a depth map of an input image; and
a processor configured to
estimate a depth map of an image using the trained model,
estimate a road profile including slope information included in the image based on the depth map of the image, and
determine a distance to an object based on a location of the object located within the image and the road profile.

2. The camera calibration apparatus of claim 1, wherein the processor is further configured to input the image into the trained model and estimate the depth map of the image based on the depth map output from the trained model.

3. The camera calibration apparatus of claim 2, wherein the trained model includes a monocular depth estimation network model.

4. The camera calibration apparatus of claim 3, wherein the processor is further configured to:
set a road area as an area of interest, among the depth map output from the monocular depth estimation network model; and
estimate the road profile in the area of interest.

5. The camera calibration apparatus of claim 4, wherein the processor is further configured to:
define a road profile model in the area of interest;
obtain parameters of the road profile model that minimize an error between the road profile model and the depth map of the area of interest; and
estimate the road profile by applying the parameters of the road profile model to the road profile model.

6. The camera calibration apparatus of claim 5, wherein the processor is further configured to obtain the parameters of the road profile model in which the error is minimized using Least Square method.

7. The camera calibration apparatus of claim 4, wherein the processor is further configured to:
obtain image coordinates of the object located within the area of interest; and
obtain real world coordinates of the object that minimize projection error based on the road profile and the image coordinates of the object.

8. The camera calibration apparatus of claim 7, wherein the processor is further configured to:
obtain a projection error function between the image coordinates projected from the real world coordinates onto the road profile and the image coordinates of the object, using a homography matrix;
obtain a Jacobian matrix for a solution vector of the projection error function;
calculate an amount of change in the real world coordinates of the projection error function using the Jacobian matrix;
update the real world coordinates of the projection error function by applying the change in the real world coordinates; and
obtain the real world coordinates at which the projection error function converges to 0.

9. The camera calibration apparatus of claim 8, wherein the processor is configured to set an initial value of the projection error function based on the road profile.

10. The camera calibration apparatus of claim 8, wherein the processor is further configured to estimate the distance to the object based on the real world coordinates where the projection error function converges to 0.

11. A camera calibration method, comprising:
obtaining an image of an environment of a vehicle by a monocular camera;
estimating a depth map of the image using a trained model configured to estimate the depth map of an input image;
estimating a road profile including slope information of a road included in the image based on the depth map of the image; and
determining a distance to an object based on a location of the object located within the image and the road profile.

12. The camera calibration method of claim 11, wherein estimating the depth map of the image further includes:
inputting the image into the trained model; and
estimating the depth map of the image based on the depth map output from the trained model.

13. The camera calibration method of claim 12, wherein the trained model includes a monocular depth estimation network model.

14. The camera calibration method of claim 13, wherein estimating the road profile further includes:
setting a road area as an area of interest, among the depth map output from the monocular depth estimation network model; and
estimating the road profile in the area of interest.

15. The camera calibration method of claim 14, wherein estimating the road profile further includes:
defining a road profile model in the area of interest;
obtaining parameters of the road profile model that minimize an error between the road profile model and the depth map of the area of interest; and
estimating the road profile by applying the parameters of the road profile model to the road profile model.

16. The camera calibration method of claim 15, wherein estimating the road profile further includes obtaining the parameters of the road profile model in which the error is minimized using Least Square method.

17. The camera calibration method of claim 14, wherein estimating the distance of the object further includes:
obtaining image coordinates of the object located within the area of interest; and
obtaining real world coordinates of the object that minimize projection error based on the road profile and the image coordinates of the object.

18. The camera calibration method of claim 17, wherein estimating the distance of the object further includes:
obtaining a projection error function between the image coordinates projected from the real world coordinates onto the road profile and the image coordinates of the object, using a homography matrix;
obtaining a Jacobian matrix for a solution vector of the projection error function;
calculating an amount of change in the real world coordinates of the projection error function using the Jacobian matrix;
updating the real world coordinates of the projection error function by applying the change in the real world coordinates; and
obtaining the real world coordinates at which the projection error function converges to 0.

19. The camera calibration method of claim 18, wherein estimating the distance of the object further includes setting an initial value of the projection error function based on the road profile.

20. The camera calibration method of claim 18, wherein estimating the distance of the object further includes estimating the distance to the object based on the real world coordinates where the projection error function converges to 0.
